(19) United States
(12) Patent Application Publication
(10) Pub. No.: US 2016/0295338 A1
(43) Pub. Date: Oct. 6, 2016

(54) MICROPHONE DIAPHRAGM

(71) Applicant: VORBECK MATERIALS CORP., Jessup, MD (US)

(72) Inventors: JOHN S LETTOW, WASHINGTON, DC (US); DAN F SCHEFFER, FREDERICK, MD (US); KENNETH E FRITSCH, ARNOLD, MD (US)

(73) Assignee: VORBECK MATERIALS CORP., JESSUP, MD (US)

(21) Appl. No.: 15/087,633

(22) Filed: Mar. 31, 2016

Related U.S. Application Data
(60) Provisional application No. 62/140,496, filed on Mar. 31, 2015.

(51) Int. Cl. H04R 31/00; H04R 23/00; H04R 7/10

(52) U.S. Cl. CPC H04R 31/003; H04R 7/10; H04R 23/008; H04R 2307/023

(57) ABSTRACT

Embodiments of the present invention relate to graphene-based microphone diaphragms. In one embodiment, a acoustic wave sensor comprises a diaphragm comprised of a graphene-based composition, wherein the diaphragm has a first side at least partially covered with a reflective material. An emitter fiber is positioned proximate to the diaphragm, wherein the emitter fiber transmits light towards the first side. A collector fiber is positioned proximate to the diaphragm, wherein the collector fiber captures at least a portion of light reflected by the first side, wherein the collector fiber is in communication with a detector. A converter is in communication with the detector and converts a signal received by the detector to a digital signal for processing. The portion of light that is captured as a result of diaphragm distortion is different than the portion of light captured in the absence of diaphragm distortion. The graphene-based composition includes graphene sheets.

### CROSS-REFERENCE TO RELATED APPLICATIONS

This application claims priority to U.S. Provisional Application No. 62/140,496 filed Mar. 31, 2015, which is hereby incorporated herein by reference.

### BACKGROUND

The present invention relates generally to microphones and specifically to graphene-based microphone diaphragms. Microphones typically are acoustic-to-electric transducers or sensors that convert sound into an electrical signal. Microphones typically include a pressure sensitive diaphragm that can convert sound to mechanical motion, which can subsequently be converted to an electrical signal. Microphone varieties are typically categorized by the transducer type that is incorporated therein, for example, condenser, dynamic, ribbon, carbon, piezoelectric, fiber optic, liquid, pressure-gradient, and microelectric-mechanical system (MEMS). In certain microphones, the diaphragm can be positioned between a fixed internal volume of air and the environment, which allows the microphone to respond uniformly to pressure from a plurality of directions. In other microphones, the diaphragm can be at least partially open on both of its sides, which can result in pressure differences between the two sides that gives the microphones directional characteristics.

### BRIEF DESCRIPTION OF THE DRAWINGS

FIG. 1 depicts a sensor, generally 100, in accordance with an embodiment of the present invention.

FIG. 2 depicts fabrication steps, in accordance with an embodiment of the present invention.

FIG. 3 depicts additional fabrication steps, in accordance with an embodiment of the present invention.

FIG. 4 depicts additional fabrication steps, in accordance with an embodiment of the present invention.

FIG. 5 depicts additional fabrication steps, in accordance with an embodiment of the present invention.

FIG. 6 depicts additional fabrication steps, in accordance with an embodiment of the present invention.

FIG. 7 depicts additional fabrication steps, in accordance with an embodiment of the present invention.

FIG. 8 depicts additional fabrication steps, in accordance with an embodiment of the present invention.

### DETAILED DESCRIPTION

The descriptions of the various embodiments of the present invention have been presented for purposes of illustration but are not intended to be exhaustive or limited to the embodiments disclosed. Many modifications and variations will be apparent to those of ordinary skill in the art without departing from the scope and spirit of the described embodiments. The terminology used herein was chosen to best explain the principles of the embodiments, the practical application or technical improvement over technologies found in the marketplace, or to enable others of ordinary skill in the art to understand the embodiments disclosed herein.

Certain terminology may be employed in the following description for convenience rather than for any limiting purpose. For example, the terms “forward” and “rearward,” “front” and “rear,” “right” and “left,” “upper” and “lower,” and “top” and “bottom” designate directions in the drawings to which reference is made, with the terms “inward,” “inner,” “interior,” or “inboard” and “outward,” “outer,” “exterior,” or “outboard” referring, respectively, to directions toward and away from the center of the referenced element, the terms “radial” or “horizontal” and “axial” or “vertical” referring, respectively, to directions or planes which are perpendicular, in the case of radial or horizontal, or parallel, in the case of axial or vertical, to the longitudinal central axis of the referenced element, and the terms “downstream” and “upstream” referring, respectively, to directions in and opposite that of fluid flow. Terminology of similar import other than the words specifically mentioned above likewise is to be considered as being used for purposes of convenience rather than in any limiting sense.

In the figures, elements having an alphanumeric designation may be referenced herein collectively or in the alternative, as will be apparent from context, by the numeric portion of the designation only. Further, the constituent parts of various elements in the figures may be designated with separate reference numerals which shall be understood to refer to that constituent part of the element and not the element as a whole. General references, along with references to spaces, surfaces, dimensions, and extents, may be designated with arrows. Angles may be designated as “included” as measured relative to surfaces or axes of an element and as defining a space bounded internally within such element therebetween, or otherwise without such designation as being measured relative to surfaces or axes of an element and as defining a space bounded externally by or outside of such element therebetween. Generally, the measures of the angles stated are as determined relative to a common axis, which axis may be transposed in the figures for purposes of convenience in projecting the vertex of an angle defined between the axis and a surface which otherwise does not extend to the axis. The term “axis” may refer to a line or to a transverse plane through such line as will be apparent from context.

Microphones typically are acoustic-to-electric transducers or sensors that convert sound into an electrical signal. Microphones typically include a pressure sensitive diaphragm that can convert sound to mechanical motion, which can subsequently be converted to an electrical signal. Microphone varieties are typically categorized by the transducer type that is incorporated therein, for example, condenser, dynamic, ribbon, carbon, piezoelectric, fiber optic, liquid, pressure-gradient, and micro-electro-mechanical-system (MEMS) microphones. In certain microphones, the diaphragm can be positioned between a fixed internal volume of air and the environment, which allows the microphone to respond uniformly to pressure from a plurality of directions. In other microphones, the diaphragm can be positioned in a manner to be at least partially open on both of its sides, which can result in the formation of pressure differences between the two sides of the diaphragm and results in directional detection characteristics.

Embodiments of the present invention seek to provide graphene-based microphone diaphragms. As used herein, the term microphone and sensor are interchangeable and both denote an electrical device that detects acoustic pressure waves. Other embodiments of the present invention seek to provide microphone diaphragms that comprise a graphene-based composition having graphene sheets. Still other embodiments of the present invention seek to provide printed microphone diaphragms. Additional embodiments of the present invention seek to provide microphone diaphragms that are coated with a reflective material or a metal, which includes, but is not limited to, silver, aluminum, lead, gold, platinum, rhodium, copper, magnesium, brass, bronze, titanium, zirconium, nickel, tantalum, tin, and/or an alloy thereof.

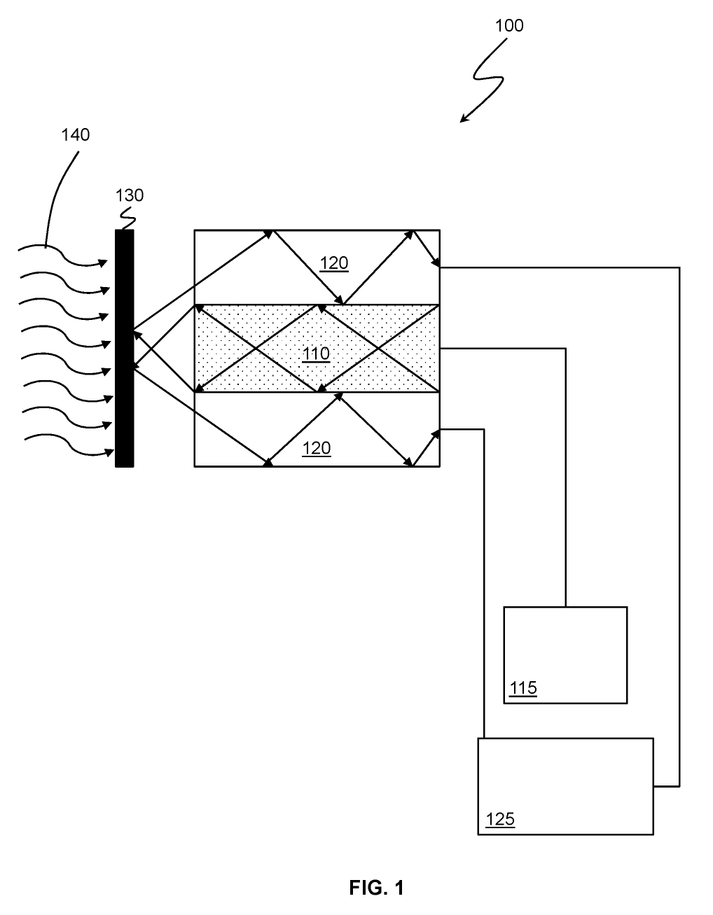

FIG. 1 depicts a sensor, generally 100, in accordance with an embodiment of the present invention. Sensor 100 is a fiber optic microphone. Sensor 100 may comprise a housing (not shown) that includes reflective diaphragm 130, which can transmitted by photo-emitter 110 to photo-collectors 120. Photo-emitter 110 and/or photo-collectors 120 can be optical fibers. Photo-emitter 110 can be a laser. Sensor 100 can detect pressure wave 140. Upon a change in atmospheric pressure, pressure wave 140 can cause reflective diaphragm 130 to distort, which can result in a change in the distance between reflective diaphragm 130 and photo-collectors 120 and a subsequent modulation of the quantity of light that reflective diaphragm 130 reflects towards photo-collectors 120, wherein the amount of light received by photo-collectors 120 is proportional to the force of pressure wave 140.

Sensor 100 has a detectable frequency range that can be increased or decreased by decreasing or increasing, respectively, the thickness (i.e. cross-section) of at least a portion of reflective diaphragm 130. As the thickness of reflective diaphragm 130 decreases, the quantity of force that is required by pressure wave 140 to distort reflective diaphragm 130 decreases. As the quantity of force with which pressure wave 140 impacts reflective diaphragm 130 decreases, the thickness of at least a portion of reflective diaphragm 130 can be decreased to facilitate the distortion of reflective diaphragm 130 and detection of pressure wave 140. Photo-emitter 110 can be a fiber optic thread having a photo-emitting first end facing reflective diaphragm 130 and a second end in communication with a photo-source, such as component 115. Photo-emitter 110 can be in communication with component 115, which is an electrical device that can transmit generated light via photo-emitter 110. Photo-collectors 120 can be a fiber optic thread having a photo-collecting first end facing reflective diaphragm 130 and a second end in communication with a photo-detector, such as component 125. Photo-collectors 120 can be in communication with component 125, which is an electrical device that can quantify light received via photo-collectors 120.

Although not shown, components 115 and 125 can be a single component. Components 115 and/or 125 can be in communication with a computing device that controls the operation of components 115 and/or 125. Reflective diaphragm 130 can be positioned at least partially within a housing (not shown) in a manner to facilitate the detection of acoustic pressure (i.e. sound), for example, pressure wave 140. Photo-emitter 110 and photo-collectors 120 can be positioned proximate to reflective diaphragm 130 in a manner to maximize any distortion of reflective diaphragm 130 that results from the impact of pressure wave 140. Photo-emitter 110 can be positioned in a manner to be in approximate alignment with the central axis of the housing and/or reflective diaphragm 130. Photo-collectors 120 can be positioned proximate to photo-emitter 110. Photo-collectors 120 can be positioned radially around photo-emitter 110. Photo-collectors 120 can be positioned asymmetrically or symmetrically relative to photo-emitter 110. Although not shown, sensor 100 can comprise one or more copies of photo emitter 110 and/or photo collector 120.

Sensor 100 may have a sensitivity of up to 1100 nm/kPa and/or have an ability to detect acoustic signals having a noise density as low as 60 μPa/√Hz at 10 kHz. The distance of photo-emitter 110 and photo-detectors 120 relative to reflective diaphragm 130 can be the same or different. Reflective diaphragm 130 can be positioned proximate to photo-emitter 110 and/or photo-detectors 120 at a distance of about 50 μm to about 100 μm, about 100 μm to about 150 μm, about 150 μm to about 200 μm, about 200 μm to about 250 μm, about 250 μm to about 300 μm, about 300 μm to about 350 μm, about 350 μm to about 400 μm, about 400 μm to about 450 μm, about 450 μm to about 500 μm, about 500 μm to about 550 μm, about 550 μm to about 600 μm, about 600 μm to about 650 μm, about 650 μm to about 700 μm, about 700 μm to about 750 μm, about 750 μm to about 800 μm, about 800 μm to about 850 μm, about 850 μm to about 900 μm, about 900 μm to about 950 μm, or about 950 μm to about 1000 μm. In other embodiments, sensor 100 can be any microphone that comprises a diaphragm, including, but not limited to, condenser, dynamic, ribbon, carbon, piezoelectric, fiber optic, laser, liquid, or MEMS microphones.

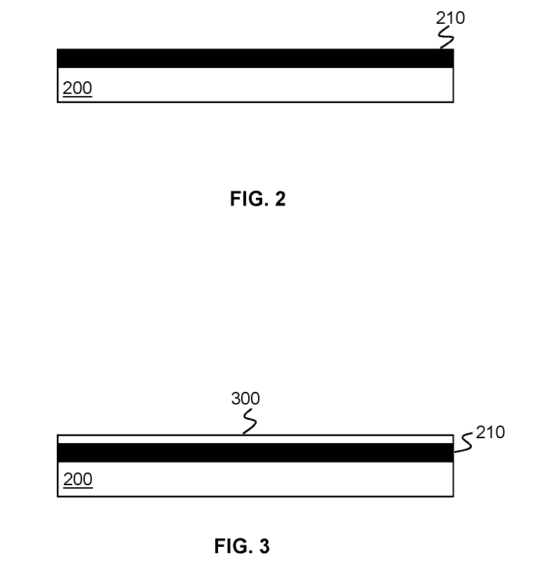

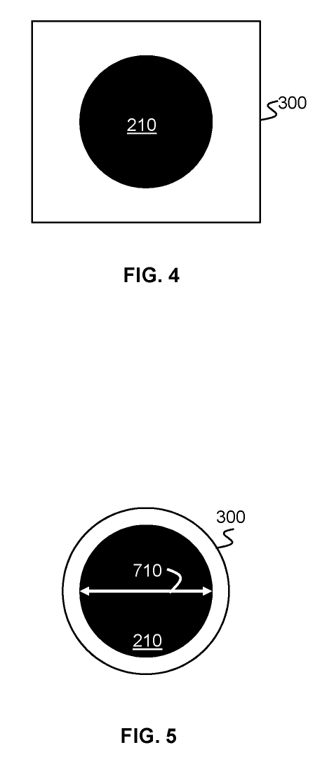

A discussion of a fabrication method is provided below followed by a discussion of applicable methods and materials. FIGS. 2-4 are disclosed herein to facilitate a discussion of the fabrication of reflective diaphragm 130, in accordance with an embodiment of the present invention. Layer 210 can be formed on at least a portion of the surface of substrate 200. Layer 210 can be comprised of the composition (discussed above). Layer 300 can be formed on at least a portion of the surface of layer 210 (discussed below). Layer 300 may comprise one or more openings having a diameter 700. Diameter 710 can be about 0.25 inch to about 0.5 inch, about 0.5 inch to about 0.75 inch, or about 0.75 inch to about 1.0 inch, The opening can have a diameter that is a sub-value of any of the aforementioned diameter ranges. Substrate 200 can be subsequently removed from layer 210, which results in the structure of FIG. 4 (a top view of the aforementioned resulting structure). Excess material can be removed from layers 210 and/or 300 to generate a substantially two-dimensional final shape as disclosed in FIG. 5. For example, the final shape and/or the one or more openings can be substantially circular, triangular, rectangular, equilateral, trapezoidal, rho or polygonal. Excess material can be removed from layers 210 and/or 300 to generate an intermediate structure that can undergo additional fabrication steps.

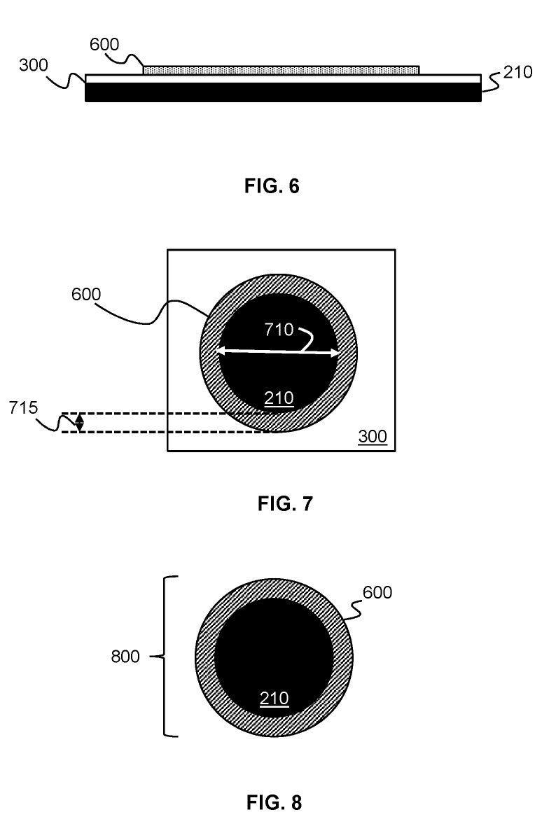

FIGS. 6-8 depict additional fabrication steps, in accordance with an embodiment of the present invention. Specifically, FIGS. 6-8 illustrate alternative fabrication embodiments for diaphragm 130. Alternatively, subsequent to the removal of layer 200, layer 600 can be applied to the surface of layer 300 opposite layer 210 to generate the structure of FIG. 6. Layer 600 can be applied using any method disclosed in the references. Layer 600 can have a thickness of about 11 μm to about 3 cm. Applicable thicknesses can include any value included in the above overall range. Applicable thicknesses can have any value range included in the above overall range. Applicable thicknesses can include any values and/or value ranges included therein. Layer 600 can comprise any material disclosed in the references (discussed above). Layer 600 can comprise PET, polyethylene, polypropylene, polyvinyl chloride, nylon, a metal, an alloy, brass, aluminum, copper, gold, silver, steal, tungsten, wood, cellulose-based materials, glass, ceramics, paper, acrylonitrile butadiene styrene, polylactic acid, polycarbonate, high impact polystyrene, high density polyethylene, and/or a photopolymer.

FIG. 7 illustrates a top view of at least a portion of the structure of FIG. 6. Layer 600 can have an inner diameter that is approximately equal to, less than, or greater than diameter 710. Although depicted as a ring, layer 600 can be any shape that complements the one or more openings of layer 300. Layer 600 can be a supporting ring structure. Layer 600 can be utilized for post process handling. Layer 600 can be printed, applied, or formed to the desired final shape (discussed above). Layer 600 can be applied by three-dimensional printing. Layer 600 can be applied as a sheet having one or more openings, wherein excess portions of the sheet can be subsequently removed. Width 715 can be about 0.5 mm to about 1.0 mm, about 1.0 mm to about 1.5 mm, about 1.5 mm to about 2 mm, about 2 mm to about 2.5 mm, about 2.5 mm to about 3.0 mm, about 3.0 mm to about 3.5 mm, about 3.5 mm to about 4.0 mm, about 4.0 mm to about 4.5 mm, and/or about 4.5 mm to about 5.0 mm. Alternatively, width 715 can be about 2 mm to about 3 cm. Width 715 can be any range of values included in the above ranges. Excess material can be removed from layers 300 and/or 210 to generate structure 800. Structure 800 can be substantially circular, oblong, triangular, rectangular, equilateral, trapezoidal, rhombi, or polygonal.

Applicable materials and methods are discussed below, in accordance with an embodiment of the present invention. Layer 210 can comprise a graphene-based composition (“the composition”). The composition can include graphene sheets. The graphene sheets and/or the composition can be formed utilizing the materials and/or methods that are disclosed in European patent application no. EP20120849213 to Redmond et al., European patent application no. EP20120849443 to Redmond et al., PCT publication no. WO2013074710 Al to Redmond et al., U.S. patent application Ser. No. 13/284,841, to Scheffer et al., U.S. patent application Ser. No. 12/848,152 to Scheffer et al., U.S. patent application Ser. No. 12/753,870 to Scheffer et al., U.S. patent application Ser. No. 13/260,372 to Varma et al., and U.S. patent application Ser. No. 13/140,834 to Scheffer et al. (“the references”) (herein incorporated by reference in their entirety). Substrate 200 and/or layer 300 can comprise one or more substrates that are disclosed in the references. Substrate 200 and/or 300 can be formed using one or more methods disclosed in the references. Layers 210 and/or 600 can be formed using a method disclosed in the references.

Reflective diaphragm 130 can be formed in any applicable manner disclosed in the references. For example, layer 210 can be applied to the surface of substrate 200 at a thickness of about 0.5 μm to about 5.0 μm, 0.5 μm to about 0.75 μm, about 0.75 μm to about 1.0 μm, about 1.0 μm to about 1.25 μm, about 1.25 μm to about 1.5 μm, about 1.5 μm to about 1.75 μm, about 1.75 μm to about 2.0 μm, about 2.0 μm to about 2.25 μm, about 2.25 μm to about 2.5 μm, about 2.5 μm to about 2.75 μm, about 2.75 μm to about 3.0 μm, about 3.0 μm to about 3.25 μm, about 3.25 μm to about 3.5 μm, about 3.5 μm to about 3.75 μm, about 3.75 μm to about 4.0 μm, about 4.0 μm to about 4.25 μm, about 4.25 μm to about 4.5 μm, about 4.5 μm to about 4.75 μm, about 4.75 μm to about 5.0 μm, about 5.0 μm to about 10.0 μm, about 10.0 μm to about 15.0 μm, about 15.0 μm to about 20.0 μm, about 20.0 μm to about 25.0 μm, or about 25.0 μm to about 30.0 μm. Applicable thickness values for the composition can include subvalues that are included in the aforementioned thickness ranges.

The applied composition can be cured at about 80° C. to about 85° C., about 85° C. to about 90° C., about 90° C. to about 95° C., about 95° C. to about 100° C., about 100° C. to about 105° C., about 105° C. to about 110° C., about 110° C. to about 115° C., about 115° C. to about 120° C., about 120° C. to about 125° C., about 125° C. to about 130° C., about 130° C. to about 135° C., about 135° C. to about 140° C., about 140° C. to about 145° C., about 145° C. to about 150° C., about 150° C. to about 155° C., about 155° C. to about 160° C., about 160° C. to about 165° C., about 165° C. to about 170° C., about 170° C. to about 175° C., about 175° C. to about 180° C., about 180° C. to about 185° C., about 185° C. to about 190° C., about 190° C. to about 195° C., about 195° C. to about 200° C. Applicable curing temperatures can include subvalues that are included in the aforementioned curing ranges.

The applied composition can be cured for about 0.5 minutes to about 1.0 minutes, about 1.5 minutes to about 2.0 minutes, about 3.0 minutes to about 3.5 minutes, about 3.5 minutes to about 4.0 minutes, about 4.0 minutes to about 4.5 minutes, about4.5 minutes to about 5.0 minutes, about 5.0 minutes to about 5.5 minutes, about 5.5 minutes to about 6.0 minutes, about 6.0 minutes to about 6.5 minutes, about 6.5 minutes to about 7.0 minutes, about 7.0 minutes to about 7.5 minutes, about 7.5 minutes to about 8.0 minutes, about 8.0 minutes to about 8.5 minutes, about8.5 minutes to about 9.0 minutes, about 9.0 minutes to about 9.5 minutes, or about 9.5 minutes to about 10.0 minutes. Applicable curing times can include subvalues that are included in the aforementioned curing time ranges.

Substrate 200 and/or layer 210 can comprise flexible and/or stretchable materials, silicones and other elastomers and other polymeric materials, metals (such as aluminum, copper, steel, stainless steel, and other metals), adhesives, heat-sealable materials (such as cellulose, biaxially oriented polypropylene (BOPP), poly(lactic acid), polyurethanes), fabrics (including cloths) and textiles (such as cotton, wool, polyesters, rayon), clothing, glasses and other minerals, ceramics, silicon surfaces, wood, paper, cardboard, paperboard, cellulose-based materials, glassine, labels, silicon and other semiconductors, laminates, corrugated materials, concrete, bricks, and other building materials. Substrates can in the form of films, papers, wafers, and/or larger three-dimensional objects.

Substrate 200 can comprise materials that are treated with coatings (such as paints) or similar materials before the layer 210 is applied. Coatings can include indium tin oxide, antimony tin oxide, and similar compositions.

One or more surfaces of layers 210 and/or 300 can be coated with a reflective material. The reflective material may comprise a metal. Applicable metals include, but are not limited to, silver, aluminum, lead, gold, platinum, rhodium, copper, magnesium, brass, bronze, titanium, zirconium, nickel, tantalum, tin, nickel, tin, steel, and/or colloidal metals. The reflective material can be applied to at least a portion of the one or more internally-facing (i.e. towards the photo-emitter) surfaces utilizing any of the aforementioned deposition methods. Alternatively, the reflective material is applied to at least a portion of the internally-facing surface of the diaphragm in a manner sufficient to reflect light to the photo-collector. The reflective material can be deposited using and applicable deposition method, which includes, but is not limited to, spattering, spraying, plating, syringe deposition, spray coating, electrospray deposition, ink-jet printing, spin coating, thermal transfer (including laser transfer) methods, screen printing, rotary screen printing, gravure printing, capillary printing, offset printing, electrohydrodynamic (EHD) printing, flexographic printing, pad printing, stamping, xerography, microcontact printing, dip pen nanolithography, laser printing, via pen or similar means.

In certain embodiments, substrate 200 is a water soluble substrate, such as a water soluble polymer. Applicable water soluble polymers include, but are not limited to, alkaline hydrosoluble copolymers of isobutylene and maleic anhydride, ISOBAM™ (developed by Kuraray Co, LTD), BIOCARE™ polymers (developed by DOW Chemicals), CELLOSIZE™ hydroxyethylcellulose (HEC) (developed by DOW Chemical), DOW™ latex powders (DLP) (developed by DOW Chemical), ETHOCEL™ ethylcellulose polymers (developed by DOW Chemical), KYTAMER™ PC polymers (developed by DOW Chemical), METHOCEL™ water soluble resins (developed by DOW Chemical), POLYOX™ water soluble resins, SoftCAT™ polymers (developed by DOW Chemical), UCARE™ polymers (developed by DOW Chemical), Sokalan® (developed by BASF), Tamol® (developed by BASF), polyacrylamides, polyacrylates, acrylamide-dimethylaminoethyl acrylate copolymers, polyamines, polyethyleneimines, polyamidoamines, polyethylene oxide, rice paper, water soluble paper, ASW-60 (developed by Aquasol Corp.), ASW-35 (developed by Aquasol Corp.), ASW-15 (developed by Aquasol Corp.), ASW-40 (developed by Aquasol Corp.), Dissolov Tech PS (developed by DayMark Technologies), and DissolovTeck 35C (developed by DayMark Technologies), and Ambergum™ water-soluble polymers.

Substrate 200 can be coated with UV-curable water soluble products. Applicable UV-curable water soluble products includes, but is not limited to, Chromafil™ (developed by Chromaline®), CCI Red-Coat (developed by Chemical Consultants, Inc.), isopropanol, Blue Screen Filler No. 60 (developed by Ulano Corp.), Green Extra Heavy Blockout No. 10 (developed by Ulano Corp.), Red Coat Blockout (developed by Lawson Screen Products, Inc.), and Ryo Screen Blockout (developed by Ryonet Corp.).

What is claimed is:

1. An acoustic wave sensor comprising:
a diaphragm comprised of a graphene-based composition, wherein the diaphragm has a first side at least partially covered with a reflective material;
an emitter fiber positioned proximate to the diaphragm, wherein the emitter fiber transmits light towards the first side;
a collector fiber positioned proximate to the diaphragm, wherein the collector fiber captures at least a portion of light reflected by the first side, wherein the collector fiber is in communication with a detector;
a converter in communication with the detector and converts a signal received by the detector to a digital signal for processing;
wherein the portion of light captured as a result of diaphragm distortion is different than the portion of light captured in the absence of diaphragm distortion; and
wherein the graphene-based composition includes graphene sheets.

2. The acoustic wave sensor of claim 1, wherein the first side is at least partially coated with an alloy, a reflective material and/or a metal.

3. The acoustic wave sensor of claim 1, further comprising a supportive structure in communication with the diaphragm, wherein the supportive structure does not substantially restrict a distortion of the diaphragm when a pressure wave make contact with the diaphragm, and wherein the supportive structure includes an opening that exposes at least a portion of the diaphragm.

4. The acoustic wave sensor of claim 1, further comprising a supportive structure in communication with the diaphragm, wherein the supportive structure has a thickness of 11 μm to about 3 cm.

5. The acoustic wave sensor of claim 1, wherein the collector fiber is aligned radially about the emitter fiber in a symmetric or asymmetric manner.

6. The acoustic wave sensor of claim 1, wherein the diaphragm is at least partially formed by printing the graphene-based composition.

7. The acoustic wave sensor of claim 1, wherein the graphene sheets have a surface area of at least about 100 m²/g to about 2,360 m²/g.

8. The acoustic wave sensor of claim 1, further comprising a supportive structure in communication with the diaphragm, wherein the supportive structure comprises a band having a width of about 2 nm about 3 cm.

9. A microphone diaphragm comprising:
a first layer having graphene sheets; and
wherein the first layer at least partially includes a reflective coating affixed thereto;
wherein the first layer at least partially distorts in response to a pressure wave impacting thereon.

10. The microphone diaphragm of claim 9, wherein the graphene sheets have a surface area of at least 100 m²/g.

11. The microphone diaphragm of claim 9, further comprising a supportive structure positioned proximate to the first layer.

12. The microphone diaphragm of claim 9, wherein the reflective coating comprises a reflective material, an alloy, and/or a metal.

13. The microphone diaphragm of claim 9, wherein the microphone diaphragm is formed in a manner to be utilized in a fiber optic microphone, a condenser microphone, a dynamic microphone, a carbon microphone, a piezoelectric microphone, a liquid microphone, a micro-electric-mechanical system microphone, or a pressure-gradient microphone.

14. A method for fabricating a microphone diaphragm comprising:
forming a first layer, wherein the first layer includes a composition having graphene sheets;
curing the first layer for a predetermined time period;
removing excess portions of the first layer to form a predefined shape.

15. The method to fabricate the microphone diaphragm of claim 14, wherein the wherein the first layer is at least partially coated with a reflective material, alloy, and/or metal.

16. The method to fabricate the microphone diaphragm of claim 14, wherein the microphone diaphragm is formed in a manner to be utilized in a fiber optic microphone, a condenser microphone, a dynamic microphone, a carbon microphone, a piezoelectric microphone, a liquid microphone, a micro-electric-mechanical system microphone, or a pressure-gradient microphone.

17. The method to fabricate the microphone diaphragm of claim 14, further comprising forming a supportive structure in a manner to be at least partially in communication with the first layer.

18. The method to fabricate the microphone diaphragm of claim 14, wherein the step of forming the first layer comprises printing the composition.

19. The method to fabricate the microphone diaphragm of claim 17, wherein the supportive structure comprises a band having a width of about 0.5 mm to about 3 cm.

20. The method to fabricate the microphone diaphragm of claim 14, wherein the diaphragm has a thickness of about 11 μm to about 3 cm.
